(19) United States
(12) Patent Application Publication
(10) Pub. No.: US 2012/0206296 A1
(43) Pub. Date: Aug. 16, 2012

(54) SELF-CHARGING POWER CONTROLLED SYSTEM FOR LOCATING ANIMALS BY GPS

(76) Inventor: Lawrence A. Wan, Malibu, CA (US)

(21) Appl. No.: 13/028,511

(22) Filed: Feb. 16, 2011

(51) Int. Cl. G01S 19/48; G01S 19/14

(52) U.S. Cl. 342/357.31; 342/357.52

(57) ABSTRACT

A portable tracking unit attached to a movable object, such as an animal's collar, includes a GPS receiver to receive GPS signals from multiple satellites for use in multilateration calculations in determining the current position of the tracking unit. A processor in the tracking unit processes the GPS data signals to determine the tracking unit's position, and a GSM mobile wireless transmitter is used to transmit the geographic coordinates of the tracking unit to a remote monitoring unit. The tracking unit also includes a motion detector that outputs a motion signal when the animal is on the move. A motion signal “wakes up” the processor that wakes up the GPS receiver and the GSM transmitter to begin calculating and transmitting the geographic coordinates of the tracking unit. The tracking unit also includes electrical generators configured to transduce mechanical motion of the tracking unit into electrical energy to recharge a battery and power devices. The portable tracking unit is fabricated monolithically in silicon with circuitry integrated with silicon micro-machined motion sensor, as well as power generators, and packaged through silicon wafer bonding. A remote computing device receives the geographic coordinates of the tracking device and indicates to a user the position of the tracking device in relation to a map. An alert may also be provided if the location of the tracking device is outside a programmed safe zone.

### BACKGROUND

The invention relates in general to a system and related method for tracking objects and more particularly, to tracking movable objects, such as animals, by means of a wide-ranging overhead location system and wireless communications.

Systems that can track objects and their movements have been in existence for some time and in certain applications, are highly desirable. Examples relating to animals, including pets, are illustrative. Animals such as scent hounds and wandering cats commonly leave their home turf to wander their neighborhoods or even go farther afield. Owners and handlers desire to know where their animals are and to be able to locate them as fast as possible. In the case of scent hounds used in law enforcement, search and rescue, or similar fields, it can be highly important to know their whereabouts, especially when a handler is busy with the animal in an active pursuit and does not have the time to report exact location coordinates.

Tracking the location of animals such as domesticated animals, pets, or wild animals that can move in unknown directions over a considerable range of territory has been a concern for a number of years. Although many pet species have keen senses of direction, it is not uncommon for pets to wander from their homes and become lost. Many pet owners have no reliable mechanism for locating their pets when they are lost. Another, but more difficult situation occurs for zoologists, filmmakers, and others who desire to study animal behavior in the wild. It is difficult to obtain initial control over such an animal so that a tracking device can be attached, and would be even more difficult to again obtain control over the animal when the batteries of that tracking device become depleted. The use of chemical sedatives and other means to subdue an animal are undesirable therefore, it would be desirable to be able to attach a sophisticated all weather tracking device that is self-powered and is self-charging. Such a tracking device would help such animal study personnel tremendously since the animal would not need to be followed twenty-four hours a day and instead, could be located when needed.

Active pet collars have been developed in the past to help notify passersby that a pet is lost. For example, some pet collars allow the pet owner to remotely activate a visual display located on the collar, such as an inflatable balloon inscribed with the message “LOST PET,” flashing lights, or an electronic display that presents a message. Although these systems may alert bystanders in the immediate vicinity that the pet is lost, they do not help the owner determine the pet's location. As a result, unless a bystander contacts the pet owner, the pet could be lost for an extended period.

Consequently, a need for tracking devices that can be attached to animal collars, formed as part of a device worn by the animal, or other means of co-location with the animal has been recognized for some time. Various attempts have been made to satisfy this need but significant problems existed with those systems. A number of systems have been proposed that employ existing wireless communication capabilities but which tend to be cumbersome, bulky, expensive, or all of the above. Through the use of the Global Positioning System (“GPS”), it is possible to provide a relatively inexpensive location system for determining the location of moving objects. The Global Positioning System is a satellite-based navigation system made up of a network of twenty-four satellites placed into orbit by the U.S. Department of Defense. The GPS works in any weather conditions, anywhere in the world, twenty-four hours a day. There are no subscription fees or setup charges to use the GPS. GPS satellites circle the earth twice a day in a very precise orbit and transmit signal information to earth. GPS receivers take this information and use triangulation to calculate the user's exact location. Essentially, the GPS receiver compares the time a signal was transmitted by a satellite with the time it was received. The time difference tells the GPS receiver how far away the satellite is. Now, with distance measurements from a few more satellites, the receiver can determine the user's position and display it on the unit's electronic map.

A GPS receiver must be locked on to the signal of at least three satellites to calculate a two-dimensional (“2D”) position (latitude and longitude) and track movement. With four or more satellites in view, the receiver can determine the user's three-dimensional (“3D”) position (latitude, longitude, and altitude). Once the user's position has been determined, the GPS receiver can calculate other information, such as speed, bearing, track, trip distance, distance to destination, sunrise and sunset time, and more. Today's GPS receivers are extremely accurate, thanks to their parallel multi-channel design. They are quick to lock onto satellites when first turned on and they maintain strong locks, even in dense foliage or urban settings with tall buildings. However, certain atmospheric factors and other sources of error can affect the accuracy of GPS receivers. Many receivers are accurate to within fifteen meters on average.

The twenty-four satellites that make up the GPS space segment are orbiting the earth about 12,000 miles (19,312 kilometers) above us. They are constantly moving, making two complete orbits in less than twenty-four hours. These satellites are traveling at speeds of roughly 7,000 miles an hour (11,265 km/hour). GPS satellites are powered by solar energy. They have backup batteries onboard to keep them running in the event of a solar eclipse, when there is no solar power. Small rocket boosters on each satellite keep them flying in the correct path.

GPS technology has typically been utilized in connection with vehicles to provide location information for companies that have large fleets of trucks in use at any one particular time. The position of an individual truck is determined by the coincident reception of signals from at least three of the GPS satellites by a satellite receiver, which position can then be stored or can be transmitted to a central receiving station via some sort of wireless link.

GPS technology has also been used for pet tracking For instance, the RoamEO® pet tracker combines GPS with a 154.60 MHz band to provide transmissions of location information from up to a mile away, even in the absence of cell phone coverage. A related RoamEO® product displays the pet's exact location, current movements, and velocity. The RoamEO® pet tracker is from White Bear Technologies, 900 Long Lake Road, Suite 100, St. Paul, Minn. 55112.

Another product uses an electronic base station in the home to activate a collar GPS communication device in the event that it receives no corresponding pet signal from within the home's perimeter. This is known as establishing a GPS fence for the animal. The weight of the electronics in these early pet collars was acceptable for dogs but not most cats.

Such tracking systems commonly include a portable device mounted to the object to be tracked, with the device relying on battery power. In many prior art examples, an animal's collar is modified to include a tracking system mounted in some way to the collar. In most cases, a robust mounting scheme is required because of the expected activities of the animal. Some animals are particularly active and may subject the tracking system to a multitude of harmful elements. Jumping fences, swimming, rain, snow, engaging other animals in activities, climbing trees, running through mud, scratching fleas, and many other activities can destroy a protruding tracking system mounted to a collar. Consequently, such tracking systems must be robust and ruggedized.

Because such collar-mounted tracking systems are portable, they are powered by batteries. It is typical for batteries to add significant weight to a collar. Those batteries must be mounted to the collar in a way that protects them from damage, thereby making them difficult to reach to change when they expire or nearly expire. Even rechargeable batteries are bulky, expensive, and can add significant weight.

Since batteries are self-contained and will eventually be depleted of all energy, they must be recharged or replaced. The recharging process typically requires that the pet owner remove the collar, or the battery from the collar, and provide wall current to the battery for a period of time that may extend into the hours. In the meanwhile, the pet does not have an active tracking system attached to it. Discarding spent batteries and replacing them with fresh batteries takes less time than recharging but can be much more expensive, and may not be desirable from the standpoint of environmental contamination control. Means to extend the life of the battery would be desirable. Thus, those skilled in the art are aware of a need for a more efficient system for powering a tracking system that is mounted to a movable object to be tracked.

Once a pet or other object is found or is being tracked, communication of that pet's position to the owner is needed. Dedicated communication equipment is undesirable in the normal day-to-day lives of most people who simply want be track their pets. The use of communication devices already in existence is preferable. The use of “smart” phones, personal digital assistants (PDAs), pagers, or other items that people may already have and which have wireless communication ability would be preferred.

It has also been recognized that reliance entirely upon the GPS for tracking missing pets, missing people, missing personal property, and other objects can be less than desirable because the missing object may be out of range of suitable GPS signals. Buildings, bridges, overpasses for roads and railroads, and other elevated structures can cause GPS signal loss on the ground. A second location system, or back-up system, not relying on the GPS would be desirable for the ability to continuously locate an object under any conditions.

Thus, those skilled in the art have recognized the need for an object tracking system that uses a wide-ranging overhead system for object location coupled with wireless communications, and a power system that extends a portable power source far longer than those in common use today. Such a system should also be relatively inexpensive so that those desiring such a tool can easily afford one. The invention fulfills these needs and others.

### SUMMARY OF THE INVENTION

Briefly and in general terms, the present invention is directed to a system and related method for tracking movable objects, including animals. A small tracking system is configured to be integrated with or mounted to an animal's collar, and is ruggedized and self-contained so that it is robust enough to survive expected abuse caused by the animal's activities. The system is active continuously, night or day in any weather. It is self-charging so that battery replacement or external charging is unnecessary.

In particular there is provided a system for tracking the location of a movable object, the system comprising a portable tracking unit attached to the movable object, the tracking unit comprising an overhead position locater receiver configured to receive position signals from a plurality of overhead position location devices and provide overhead position location data from the received position signals, a wireless communications transmitter configured to wirelessly transmit a tracking unit location signal representative of the geographic location of the tracking unit, a motion detector configured to detect when the portable tracking unit is moving and to provide a motion signal, a processor programmed to receive the motion signal and control the receiver and transmitter to operate in a normal operation mode, to receive overhead position location data from the receiver, to process the overhead position location data to calculate the present geographic location of the tracking unit and provide a tracking unit location signal; to control the transmitter to wirelessly transmit the tracking unit location signal, and to control the transmitter and receiver to operate in a low-power consumption sleep mode, a battery configured to provide electrical power to the receiver, transmitter, and processor, and an electrical energy generator configured to transduce mechanical motion of the portable tracking unit into electrical energy, the electrical energy generator connected to the battery to automatically recharge the battery.

In more detailed aspects, the motion detector comprises a two-axis motion detector and the wireless communications transmitter is configured to transmit the tracking unit location signal in at least one of real time transmission, periodic transmission, and burst transmission. Further, the portable tracking unit further comprises a memory in which is stored an identification of the tracking unit wherein the processor is further programmed to access the memory to retrieve the identification and to control the transmitter to transmit the identification with the calculated tracking unit location signal. Additionally, the tracking system further comprises a plurality of power generators, each of which is configured to transduce mechanical motion of the tracking unit to electrical energy, one of which is connected to recharge the battery, and another is connected directly to the transmitter to provide electrical power for operation thereof; others are connected to power circuits for data processing and decision making, and others are connected to power motion sensors.

In other aspects according to the invention, the portable tracking unit further comprises a memory in which is stored a series of geographical data representing a safe geographic area in which the tracking unit is expected to remain wherein the processor is also programmed to retrieve the data representing a safe geographic area, compare the calculated tracking unit location signal to the safe geographic area data, and control the transmitter to transmit an alert if the location of the tracking unit is outside the safe geographic area. Further aspects include the overhead position locater receiver being configured to receive position signals from a plurality of GPS satellites and provide GPS position location data from the received GPS position signals.

In yet another aspect, the tracking unit further comprises a radio frequency signal device programmed to transmit an RF location signal in response to receiving a predefined query signal. The tracking unit processor is further programmed to periodically transmit the RF location signal when reception of GPS signals cease for a predetermined period of time.

Yet further aspects include the tracking system further comprising a monitoring unit located remotely from the tracking unit, the monitoring unit comprising a monitoring unit memory in which is stored a series of geographical data representing a safe geographic area in which the tracking unit is expected to remain, a monitoring unit processor programmed to receive the tracking unit location signal, retrieve from the memory the data representing a safe geographic area, compare the tracking unit location to the safe geographic area data, and provide an alert signal if the location of the tracking unit is outside the safe geographic area. The remote monitoring unit comprises a personal computer having the processor, the processor being further programmed to provide the alert in auditory form and in visual form. The processor of the remote monitoring unit is further programmed to display the tracking unit's position on relation a geographical map. Furthermore, the remote monitoring unit may comprise a smart phone having the processor, the processor being further programmed to provide the alert in auditory form and in visual form.

In further more detailed aspects, the processor is further programmed to periodically monitor the motion detector to determine if motion exists, and upon no motion being detected, to start a timer of predetermined time period, and having not received a motion signal within the time period, to control the transmitter to go to a low power consumption sleep mode. In another aspect, the battery power is always provided to the motion detector even when other devices are in sleep mode, with the processor also having a low power consumption mode, but further programmed to continually monitor the motion detector for a motion signal, and upon receiving one, the processor goes to a higher power consumption mode and also controls the transmitter to a higher power consumption mode.

In another aspect, different types of linear motion electrical generators, one of which may take the form of a piezoelectric generator, are usable. Such linear motion electrical generators are formed on a silicon substrate and provide enough energy to meet the power requirements of the particular device to which they are respectively connected. The system and method are capable of operating day or night without regard to the existence of solar radiation.

In yet a further aspect, the portable tracking unit excepting the battery is fabricated monolithically in silicon with circuitry integrated with silicon micro-machined motion sensor, as well as power generators, and packaged through silicon wafer bonding whereby optimum miniaturization, lightness in weight, water and weather proofing, low energy consumption, mass batch manufacture capability are achieved.

In accordance with a method having aspects of the invention, there is provided a method for tracking the location of a movable object, the system comprising receiving position signals from a plurality of overhead position location devices, processing the received signals to extract location assist data and providing overhead position location data from the received position signals, detecting motion of the movable object and providing a motion signal, upon receiving the motion signal, processing the overhead position location data to calculate the present geographic location of the movable object and generate a movable object location signal, wirelessly transmitting movable object location signal representative of the geographic location of the movable object, providing operational power from a battery source located with the movable object, transducing mechanical movement of the movable object into electrical energy and recharging the battery source with the transduced electrical energy, operating in a low power consumption move when the movable object is stationary, receiving the geographic location signal representative of the movable object at a location remote from the movable object, and processing the received geographic location signal of the movable object and displaying the geographic location of the movable object in relation to a geographic coordinate map.

In yet further method aspects, the method further comprises powering each of the receiving and transmitting steps by separately transducing mechanical motion of the movable object and separately providing electrical energy with which to perform the receiving and transmitting steps. The method further comprises transmitting a location signal in response to receiving a predefined query signal, and periodically transmitting the location signal when reception of GPS signals cease for a predetermined period of time.

Other method aspects include fabricating devices monolithically in silicon with circuitry integrated with silicon micro-machined motion sensor, as well as power generators, and packaged through silicon wafer bonding whereby optimum miniaturization, lightness in weight, water and weather proofing, low energy consumption, mass batch manufacture capability are achieved.

The features and advantages of the invention will be more readily understood from the following detailed description that should be read in conjunction with the accompanying drawings.

### BRIEF DESCRIPTION OF THE DRAWINGS

FIG. 1 presents a diagram of an overhead tracking system in which four satellites of the Global Positioning System are being used to track an animal on the earth's surface;

FIG. 2 is a diagram of one embodiment of an animal collar that contains an animal tracking system in accordance with aspects of the invention, which is usable with the GPS shown in FIG. 1, and which is embedded into the collar with a relatively smooth outer surface;

FIG. 3 shows an alternate embodiment of an animal tracking system different from that of FIG. 2, which in this case is built into a hanging tag that is tethered to the animal's collar thereby providing easy access for battery replacement, and thereby not having a dedicated collar for the system;

FIG. 4 is a block diagram view of a movable object tracking system in accordance with aspects of the invention showing a mobile animal tracking unit comprising a collar, a processor, a communication module, an antenna, and three satellites of the GPS, three GSM cell phone towers, and a smart phone configured to show the tracked object's position on the display;

FIG. 5 presents a diagram of a GPS “fence” around a building such as a house, showing two main areas in which an animal may roam, the first being in the back yard of a house, and the second being around the grounds, each area having a pre-alert “track” and an alert “track;”

FIG. 6 is one example of a display for a user's smart phone to show the position of a tracked animal or other tracked object;

FIG. 7 is another example of a display for a user's computer showing the position of a tracked animal or other tracked object in relation to a GPS fence;

FIG. 8 is the example of an interactive display of FIG. 7 shown on a user's smart phone display;

FIG. 9 is a block diagram of a first embodiment of a tracking system in accordance with aspects of the invention including a GPS receiver, motion detector, processor, memory, battery, power generator, beacon locater system, and GSM wireless transmitter;

FIG. 10 is an elementary diagram of a micro power generator based on the Faraday induction principle;

FIG. 11 is a block diagram of a second embodiment of a tracking system in accordance with aspects of the invention including a GPS receiver, motion detector, processor, memory, battery, GSM wireless transmitter, beacon locater system, and a separate power generator for each of the more power consuming devices;

FIG. 12 present a flow chart of a method of tracking an object in accordance with certain aspects of the invention;

FIG. 13 is a flow chart of a method incorporated into the tracking method of FIG. 12 in which a beacon location method is used;

FIG. 14 shows an alternate embodiment of a miniaturized animal tracking system in the form of a tag that may be tethered to an animal's collar, showing the system, the main mounting portion, a tether plate, a battery, and a threaded cap that facilitates battery replacement;

FIG. 15 illustrates fabrication of the tracking system in monolithic configuration in silicon, that includes integrated electronic circuits, motion sensor, and power generators;

FIGS. 16, 17, and 18 illustrate micro-machined cavities on a second silicon wafer which, when bonded to the silicon layer shown in FIG. 15, results in a finished product of a portable tracking unit that is miniaturized and ruggedized.

### DETAILED DESCRIPTION OF THE PREFERRED EMBODIMENTS

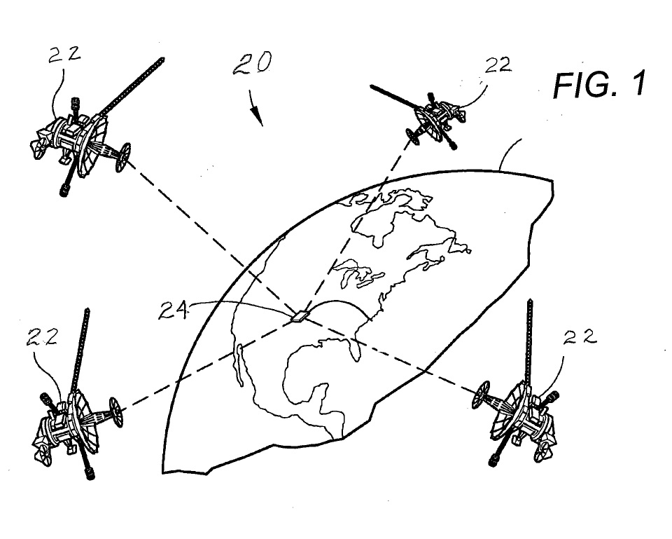

The present invention is directed to a system for tracking movable objects, such as animals, vehicles, packages, personal property, portable electronic items, persons, valuable assets, and other objects. Referring now in more detail to the exemplary drawings for purposes of illustrating embodiments of the invention, wherein like reference numerals designate corresponding or like elements among the several views, there is shown in FIG. 1 an overhead position locater system using the Global Positioning System (GPS) 20 satellites 22 to locate a moving object 24 on earth, showing in this case, the use of four satellites 22. Through multilateration by using four satellites in this case, not only can the object's 24 lateral location be determined with accuracy, the altitude of that object can also be determined. The determination of altitude is not necessary in certain tracking systems and involves the employment of additional calculations that take additional time, additional computing power, and additional memory. The embodiments herein are described in relation to multilateration, although the number of satellites, or overhead reference location points, may differ. Additionally, the location system discussed below is an overhead position system, which encompasses the GPS since it uses satellites. Other overhead position systems may be usable, provided that they offer a means to locate an object with reasonable accuracy.

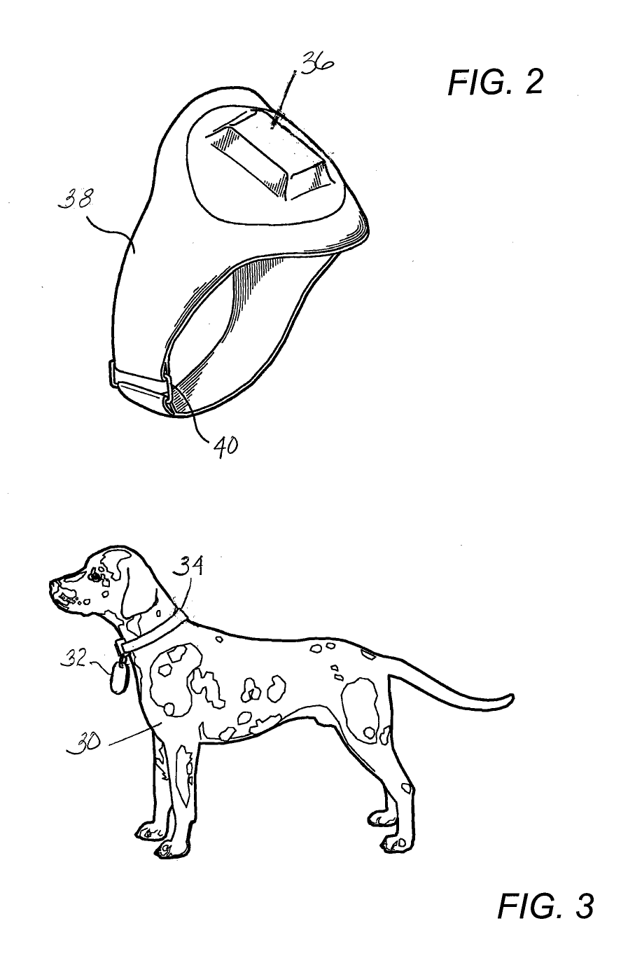

Turning now to FIGS. 2 and 3, there is shown a portable tracking unit that is either integrated into or mounted to a collar of an animal 30. In FIG. 2, the portable tracking unit 36 has been integrated into the collar 38 while in FIG. 3, the portable tracking unit has been attached to the collar by means of a link or ring 33, such as one used to attach a license tag to the collar. In one embodiment, the ring may be used to hold both the license plate and the portable tracking unit. In accordance with the embodiment of FIG. 3, the portable tracking unit 32 is mounted to the dog collar 34. In both cases, the portable tracking unit is attached to the movable object 30 to be tracked, in this case a dog. Such attachment, and the overall design of the tracking unit must be such that the unit will withstand the level of abuse expected to be encountered when a dog undergoes its typical daily activities. Rain, ice, snow, heat, mud, ocean water, scratching, rolling on the ground, playful and other contact with dogs, can all be expected on any particular dog and the tracking unit and its mounting to the dog must be ruggedized to withstand all such conditions. In the case of FIG. 2, the collar includes a closure 40 used to keep the collar on the dog. In the case of FIG. 3, the tracking unit 36 has been ruggedized and the mass of both the license plate and tracking unit are small so that the license plate will not damage the tracking unit if the two collide.

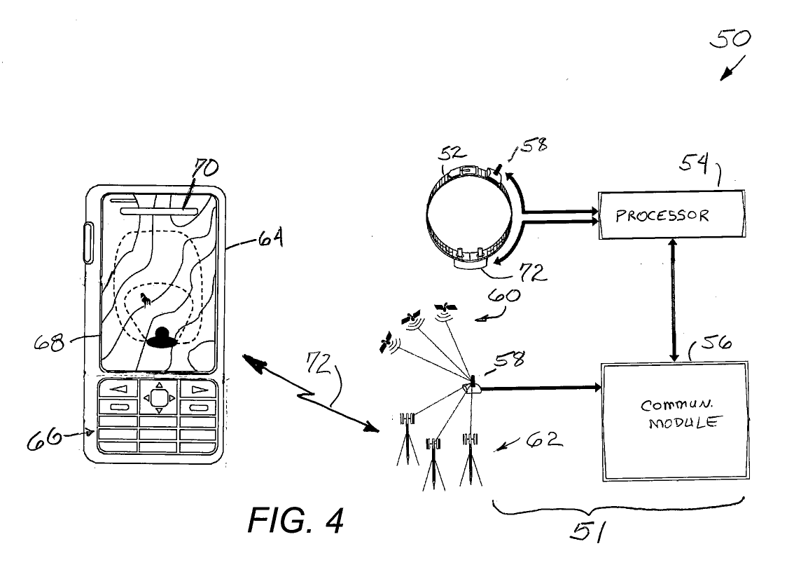

Referring now to FIG. 4, there is illustrated a system 50 for tracking and locating animals in accordance with aspects of the present invention. The system includes a portable tracking unit 51 that comprises a collar 52 on which is located a processor 54, a communication module 56, and an antenna 58, with the antenna being shown for purposes of clarity here in two places, although in reality, they are the same. Furthermore, the antenna 58 may comprise two or more antenna devices to handle the different frequencies of the GPS satellites 60, and the frequency of the GSM wireless device 62. Also shown in the system 50 is a remote monitoring unit 64 taking the form here of a smart phone, such as an iPhone. In this embodiment, the smart phone receives the wireless output 72 from the GSM transmitter (not shown) of the tracking unit 51. The smart phone includes an input device 66 such as a keypad, a display 68 for communicating information visually, and a speaker 70 for communicating information audibly. The smart phone includes an application program permitting the location data 72 from the portable tracking unit 51 to be processed and displayed in different formats. In the display of FIG. 4, the object being tracked, in this case a dog and its owner are superimposed on a geographic map and dashed lines show a “safe zone” in reference to the owner, as is discussed below. In FIG. 4, the antenna 58, the processor 54, and the communication module 56, along with other components, form parts of the collar 52 and the portable tracking unit 51. They have been separated here for illustrative purposes only, to show components of the collar.

Although shown as receiving the location data by transmission from GSM transmitter, the remote monitoring unit may receive the location data by other means. Additionally, the embodiment of FIG. 4 shows the battery 72 that powers the portable tracking unit 51 mounted to the collar 52 nearly opposite the portable tracking unit 51. Because batteries are typically heavier than the electronics of the tracking unit, mounting the battery at this location would allow gravity to orient it to a lower position on the collar with the tracking unit 51 at a higher position on the collar. If in another embodiment, the battery is relatively light, this feature may not exist.

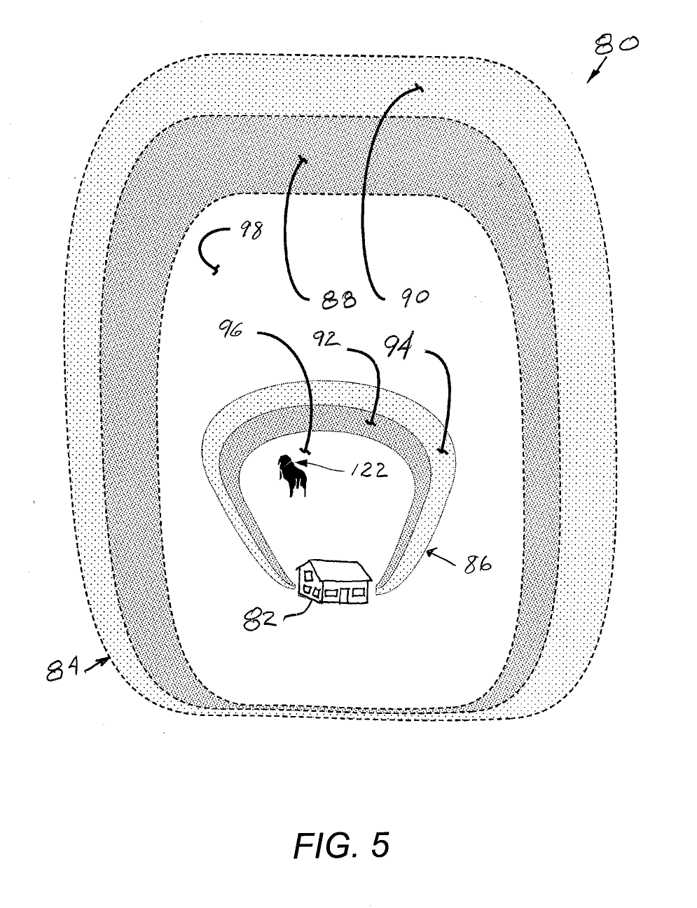

FIG. 5 shows a larger view of a display 80 provided a GPS application program in which a “GPS fence” is created around a landmark. In this case, the landmark is a building 82. Two specific geographic safe zones 84 and 86 are shown. Each zone includes a safe band and a warning band. For example, in the first safe zone 84 (outer zone), the safe band 88 is a darker gray than the warning band 90. In the second zone 86 (inner zone), the safe band is shown by the numeral 92 and the warning band by numeral 94. Non-training areas are within the safe zones and are indicated by numerals 96 and 98. Such zones and bands may be used in training a dog for guard duty or otherwise. The zones and bands therein are provided by GPS coordinates through an application program such as that contained in the smart phone 64 of FIG. 4 and in another embodiment, may be generated by the processor 54 of the portable tracking unit 51.

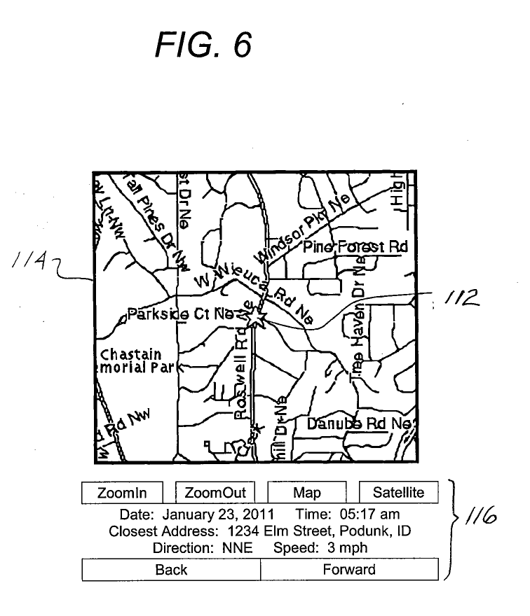

FIG. 6 presents a mapping function usable with the GPS location of a movable object. Using the tracking system of FIG. 4, the movable object 112 has been tracked to particular GPS geographic coordinates. A map of the area 114 is overlayed on that tracked location of the movable object so that the user of the system may more easily visualize the object's location, by seeing the geography surrounding that location. Application program features may provide various functions. In this embodiment, the application allows for zooming in, zooming out, overlaying a map, or overlaying a satellite image. The nearest street address, direction of travel, and speed of travel data are also provided 116 about the movable object. Additional features may be provided, such as directions to the object, the time to get there, elapsed time since the object left a safe zone, and others. In this case, a map is shown with street names and intersections. This mapping function may be displayed on a smart phone, a PDA, portable or stationary computers, or other devices.

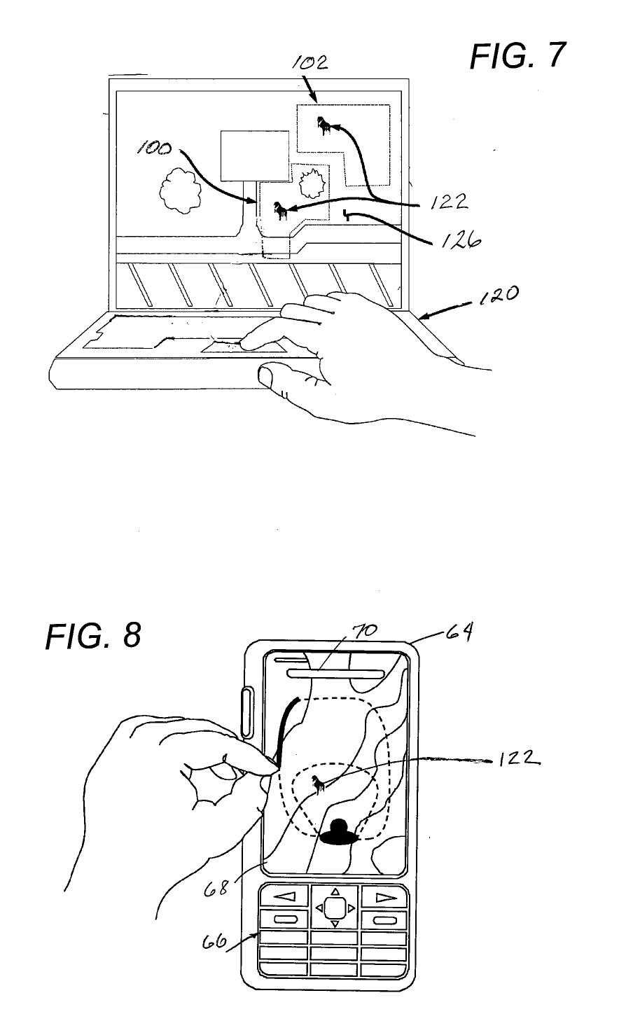

FIG. 7 provides a view of a remote monitoring unit, which in this case comprises a laptop computer 120, used to present the GPS fence display similar to that of FIG. 5. The dogs are indicated by numeral 122 and the zones are indicated by numerals 100 and 102. Pointing devices on the laptop, such as a touch pad 124, can be used to zoom in/out, as well as assist in altering the display 126 as needed. FIG. 8 presents the smart phone 64 of FIG. 4 with an active touch screen 128 with which a user can alter the display in various ways as programmed by the application program.

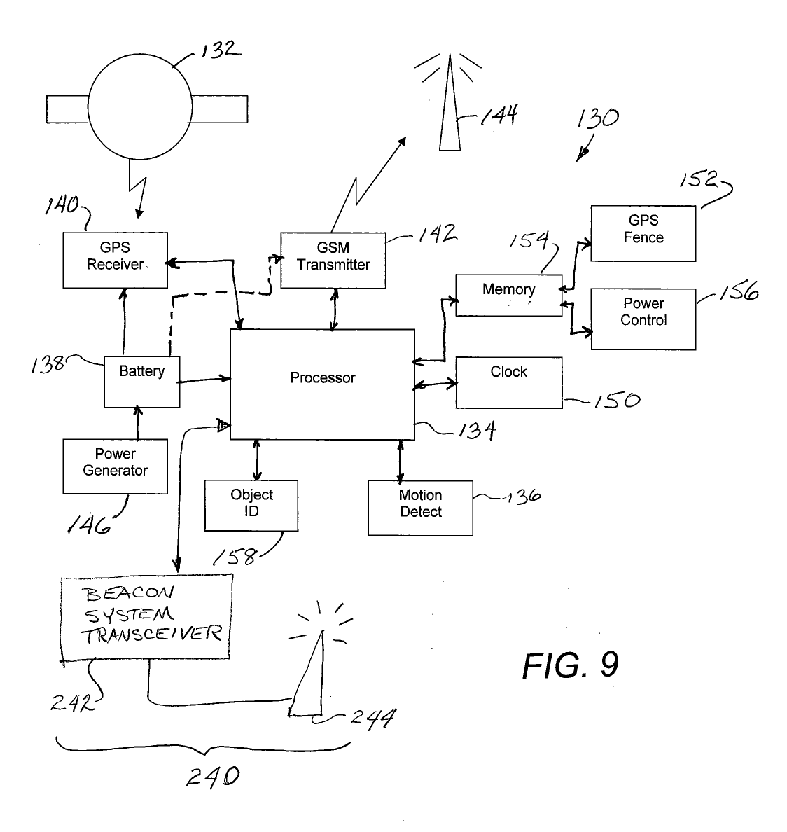

Turning now to the block diagram of FIG. 9, a block diagram of a portable tracking unit 130 is shown. The tracking unit is designed to function with the GPS, and in the diagram, a single GPS satellite 132 is shown, although in practice, three or more may be in contact simultaneously. A processor 134 is connected with, and provides power to, a motion detector 136. When no motion is indicated by the detector 136, the processor controls other devices in the tracking unit 130 to go to a sleep mode in which they consume much less power. A battery 138 is used to provide the electrical power for the tracking unit, and effective or “smart” power control is an aspect of the embodiment. In one embodiment, the motion detector is a dual-axis detector, which permits it to be more sensitive with tracked objects such as animals.

Upon receiving a motion signal from the motion detector 136, the processor 134 transitions to an operational power level mode and controls the GPS receiver 140 to begin full operation. The GPS receiver receives position data signals from the GPS, including the satellite 132 shown. The receiver processes the GPS signals and provides position location data to the processor 134. The processor then transmits that geographic location data to a remote monitoring unit (not shown) by means of the GSM transmitter 142. The figure shows transmission to a cell tower 144, as an example. In another aspect in accordance with principles of the invention, an electrical generator 146 is used to recharge the battery 138. This generator is responsive to mechanical motion of the tracking unit and transduces or converts such mechanical motion to electrical energy. An example of such a transducer is a Faraday magnetic induction power generator.

The embodiment of FIG. 9 also includes a beacon location system. Where there is insufficient GPS signal strength, the beacon system may then transmit a short RF signal every three minutes or at another time interval. The system may be turned on by remote control or automatically when the tracking unit detects that the GPS signal is not being received or is intermittent, or for other reasons. In one embodiment, the beacon location system may only be activated when the animal is outside its pre-set perimeter. A hand-held directional antenna can then be used to receive the short RF signal and determine the direction of the animal by an audible signal that beeps louder as the directional antenna is turned toward the direction of the beacon signal.

More particularly, a beacon system transceiver 242 is connected with the processor 134 in this embodiment and to an RF beacon antenna 244. In one embodiment, the transceiver has a low power mode that enables it to remain on at a very low power level and “listen” for an activation signal when someone wants to manually activate the beacon location system. When such an activation signal is received, the beacon transceiver switches to a higher power mode for operation and begins the transmission of the short RF beacon location signals. In the case where the system is to be activated due to the lack of usable GPS signals, the processor may then be used to activate the beacon transceiver 242. Although shown as separate components, the beacon antenna may be incorporated into another antenna, and the beacon transceiver may also be incorporated into another radio unit, such as the GSM transmitter. Power usage of the beacon system is closely monitored and the transmission of beacon signals may be “timed out” after a certain period of time or for other reasons. The transceiver would then be placed into a lower power mode to conserve battery power.

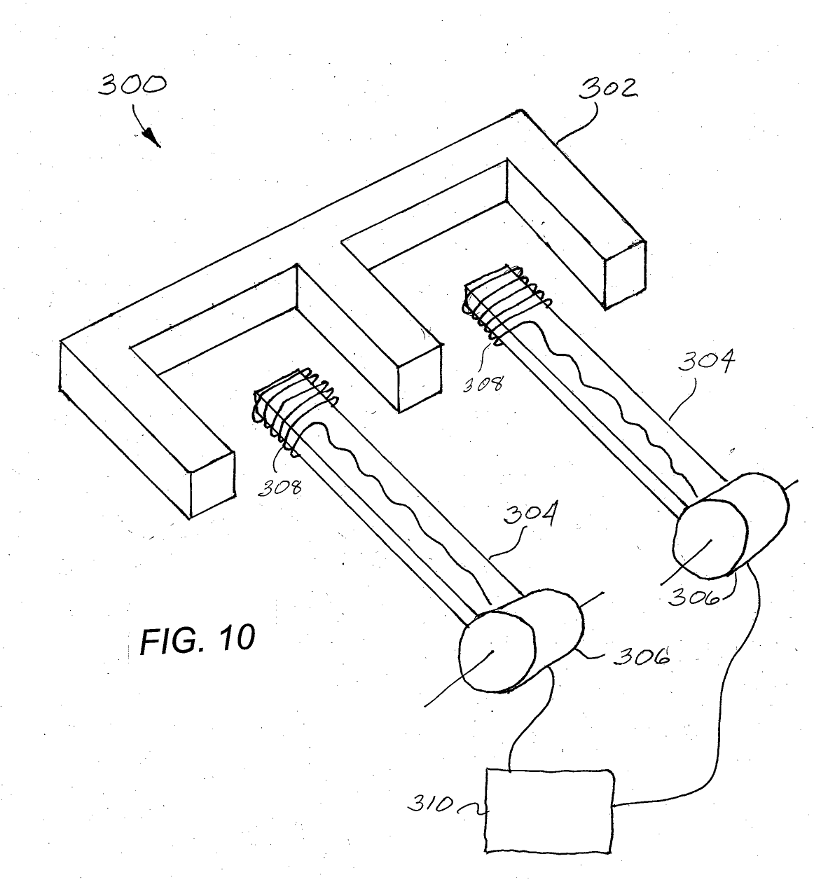

Turning now to FIG. 10, a rough schematic of a micro-power generator 300 is shown that may be used in a tracking unit. The principle of relative movement between a wire coil and a magnet in accordance with Faraday's principles of induction is employed. Micro-currents are generated by movement of the cantilevers in relation to the stationary magnets. Although this may be implemented in different ways, in the case of FIG. 10, stationary magnets 302 receive two cantilevered pivoting arms 304 between them. In this embodiment, the arms are mounted at pivots 306 at one end that permit each arm to make reciprocal motion. Each arm has an electrical coil 308 at its end that will move through the magnetic field created by a respective magnet and thereby generate micro-currents. As the tracking unit moves, the arms 304 will swing about their pivot mountings 306 thereby moving in relation to the magnetic field created by the magnets and create micro-currents of electrical energy.

Those electrical micro-currents may be directed to a diode, capacitor, or battery 310 for use in the tracking unit. They may be connected in series to raise the voltage. Although coils are disposed on the arms in this embodiment, in another embodiment, the arms may have magnets that move within stationary coils. Through micro-machining, electro-deposition, and other fabrication techniques, such micro-power generators 300 can be made very small. The number of cantilevered arms 304 may be increased where more power is necessary. Arms 304 may be set at angles to other arms so that a multiple-axis generator results for converting actions of the tracked object in different directions into electrical power.

Although a pivoting embodiment is shown for implementation of a power generator in this embodiment, it is only one example. Other arrangements, such as a sliding system, may also work.

In other aspects of the tracking unit shown in FIG. 10, a clock 150 exists for use by the processor 134 in many of its functions. One of those functions is controlling the devices of the tracking unit 130 to return to the sleep mode when the object being tracked is motionless for a predetermined period of time. A power control program 156 stored in the memory 154 may be accessed by the processor, run, and various functions performed. Accordingly, once the motion detector 136 indicates that no motion is detected, such as by the failure to send a motion signal, the processor will time the period of no motion. Upon reaching the predetermined time period set by the smart power control program 156, the processor will then control the GSM transmitter 142 to power down into a sleep mode, since it is likely the largest consumer of electrical energy in the tracking unit. The receiver 140 and beacon locater transceiver 242 will also be powered down to the sleep mode.

Other functions performed by the processor 134 of the tracking unit 130 may include processing the GPS location data against a GPS fence 152 stored in the memory 154. Should the object tracked be on the wrong side of the GPS fence, the processor may transmit an alert through the GSM transmitter 142 to inform the remote monitoring unit of the need to do something about the position of the tracked object. Additionally, the tracking unit of this embodiment includes a hardware identification value 158 that the processor transmits periodically to the remote monitoring unit.

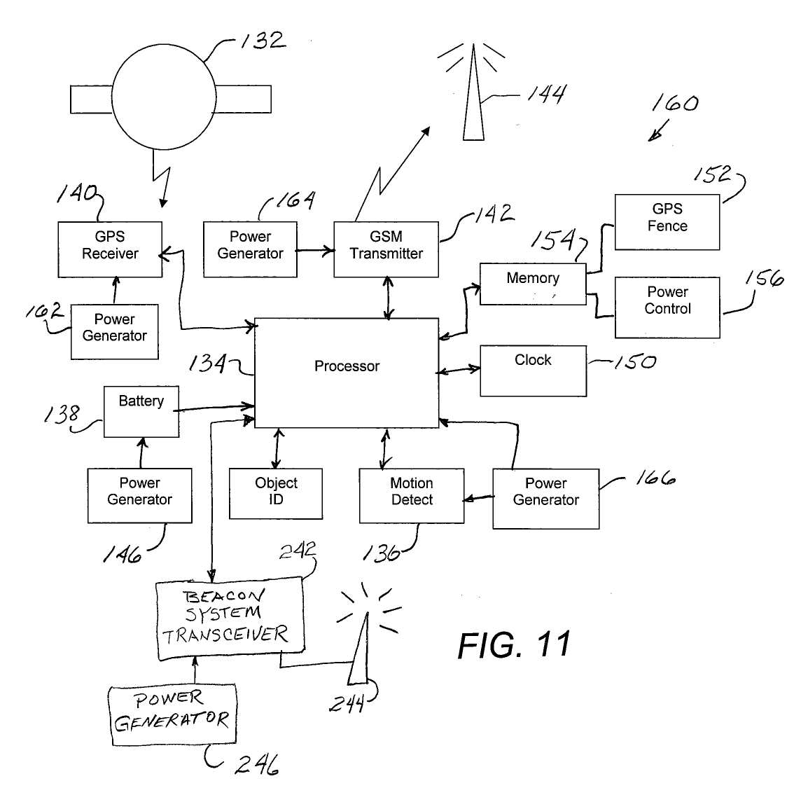

Turning now to the portable tracking unit 160 shown in block diagram form in FIG. 11, it will be noted that most components are identical with those of FIG. 10. However, the unit of FIG. 11 includes four additional power generators that are used to individually power devices in the unit. In addition to the power generator 146 used to recharge the battery 138, the GPS receiver has its own power generator 162, the GSM transmitter has its own power generator 164, the processor 134 has its own power generator 166, and the beacon locater transceiver 242 also has its own power generator 246 in this embodiment. Each of these additional power generators is of the transducing type and therefore, they produce no power unless the object being tracked provides motion. Upon becoming stationary, the tracking unit 160 must again rely on battery power for any remaining functions to be accomplished. However, during times of motion of the object, the additional power generators can take a large load off the battery and may in fact be able to handle the entire electrical power requirements of the respective devices, as well as provide charging power to the battery.

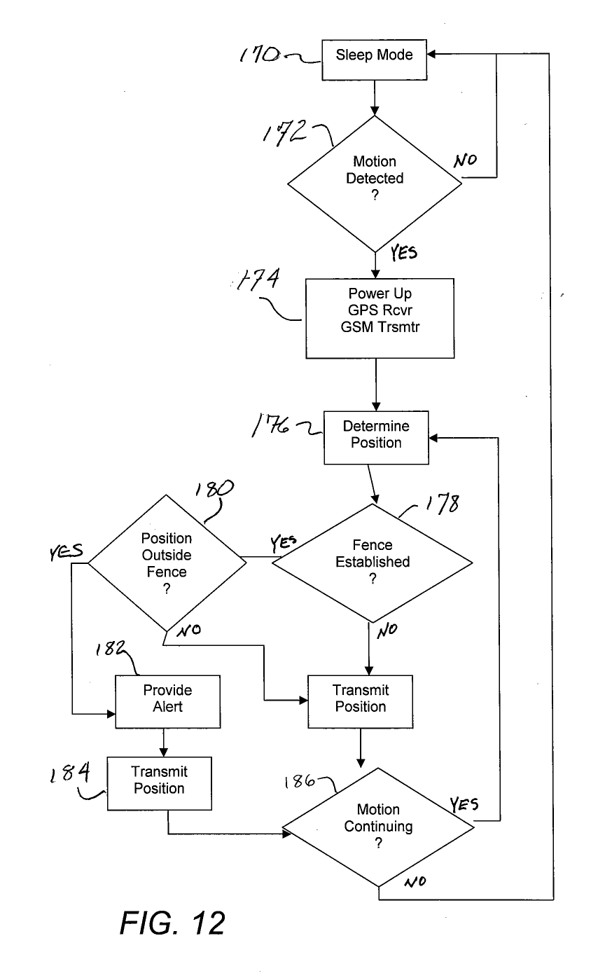

FIG. 12 provides a flow diagram of an embodiment of an object tracking method in accordance with aspects of the invention. Starting at sleep mode 170, the method continuously monitors for the existence of motion 172 of the object being tracked. Upon finding motion, the GPS receiver and GSM transmitter are powered up 174, as well as any other devices needed to track the object. The position of the object being tracked is determined 176. The method then checks to determine if a logical fence has been stored 178 within which, or outside of which the object was to remain. If so, the method determines whether the position of the object is outside this fence 180. If so, the method provides an alert 182, transmits the actual position 184 with the alert and continues to check for motion of the object 186. If there is no fence or not alert, the method continues to check for motion 186. If motion discontinues for a certain period of time, the method returns to sleep mode 170.

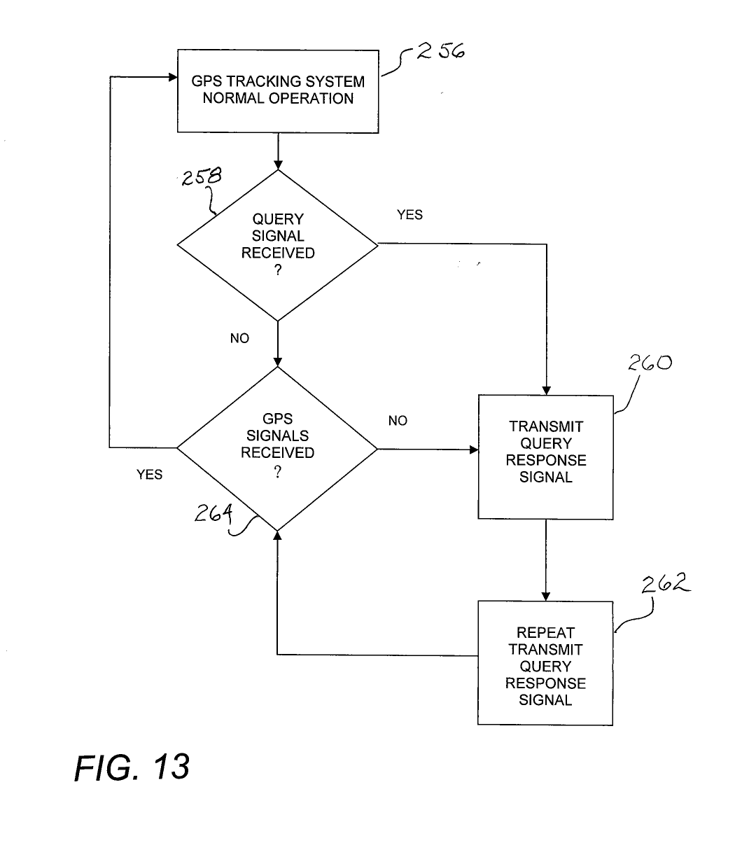

FIG. 13 is another block diagram of an embodiment that illustrates the operation of a beacon locater system according to programming in one embodiment. The flow begins with the tracking system in normal operation 256. The beacon locater transceiver is in a low power listening mode in one embodiment, and if a “query” signal is received 258 through the beacon locater antenna, the beacon transceiver will power up to a higher level and transmit a query response signal 260. The response signal will be rebroadcast for a time period in accordance with current programming 262. At the end of that period, the program then checks for the existence of GPS signals being received 264. If they are being received, the program determines that normal operation is now occurring and returns to the normal operation mode 256. However, if GPS signals are not being received, the program will once again cause the beacon transceiver to transmit responses to query signals 260, which will be rebroadcast for a selected or predetermine period of time or number of repetitions 262, and then the method continues as described above.

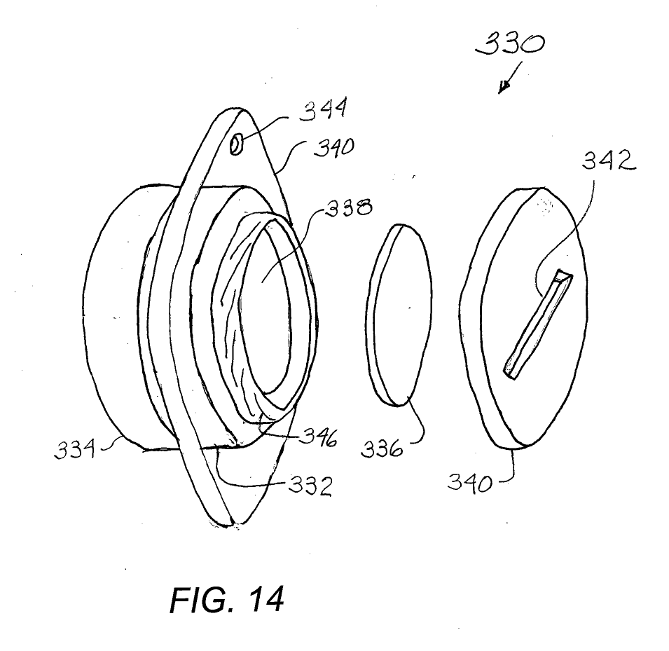

FIG. 14 is a block diagram of an embodiment of a portable tracking unit 330 that has been designed for linking to the collar of an animal, such as is shown in FIG. 3, or otherwise being attached to a movable object through a tether. The unit 330 includes a base 332 that may include the basic substrate for the radios, processor, memory, power generators, motion sensor, and other data and power components of the tracking unit. The antennas may be mounted within a substrate cap 334 or to the substrate within the base, depending on the configuration desired. The other side of the base 332 includes a socket 338 for receiving a replaceable “coin-type” battery 336. The socket 338 is specifically designed for receiving the battery and making firm contact with the correct terminals. A battery cap 340 is designed to fit tightly to the battery-side of the base 332 to retain the battery in place with electrical contacts for its terminals. The battery cap 340 includes a rotation slot 342 for receiving a common coin that may be used for leverage to rotate the battery cap onto or off of the base. A tether plate 340 includes a tether-receiving hole 344 through which a tether, such as a ring or wire, may be passed for the purpose of tethering the tracking unit to the collar of an animal or other object.

Many construction details are not shown in FIG. 14 but are well within the skill of those in the art. For example, techniques may be employed to make the tracking unit 330 waterproof, shock proof, easy to assemble, and ruggedized for rough handling. Although threads 346 are shown in FIG. 14 for attaching the battery cap to the base, another attachment means may be used. Further, if a rechargeable battery is to be used, the configuration of FIG. 14 may vary depending on how the battery recharging is to be done.

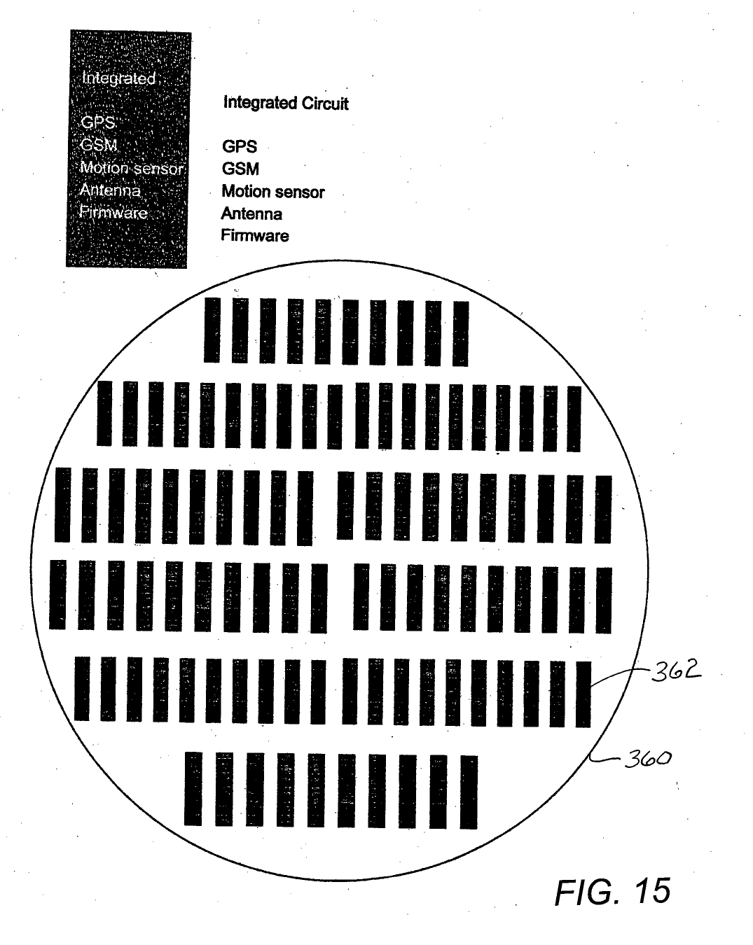

FIG. 15 provides an illustration of fabricating the entire portable tracking unit 330 in a monolithic configuration in silicon. In particular, the GPS receiver, GSM transmitter, motion sensor, power generators, processor, memory, antennas, and firmware are formed on the silicon wafer 360 as an integrated circuit (IC). Depending on the ultimate size of that circuit, many such circuits may be formed. FIG. 15 shows the configuration where one-hundred such circuits are formed on a single wafer. Only one such circuit 362 is indicated by a drawing numeral so that clarity of the drawing will be preserved. However the numeral 362 is meant to be indicated for every IC on the drawing. The IC is deposited and the motion sensor and power generators may be plasma micro-machined onto the same silicon wafer. Each rectangle in FIG. 15 represents the composite device die.

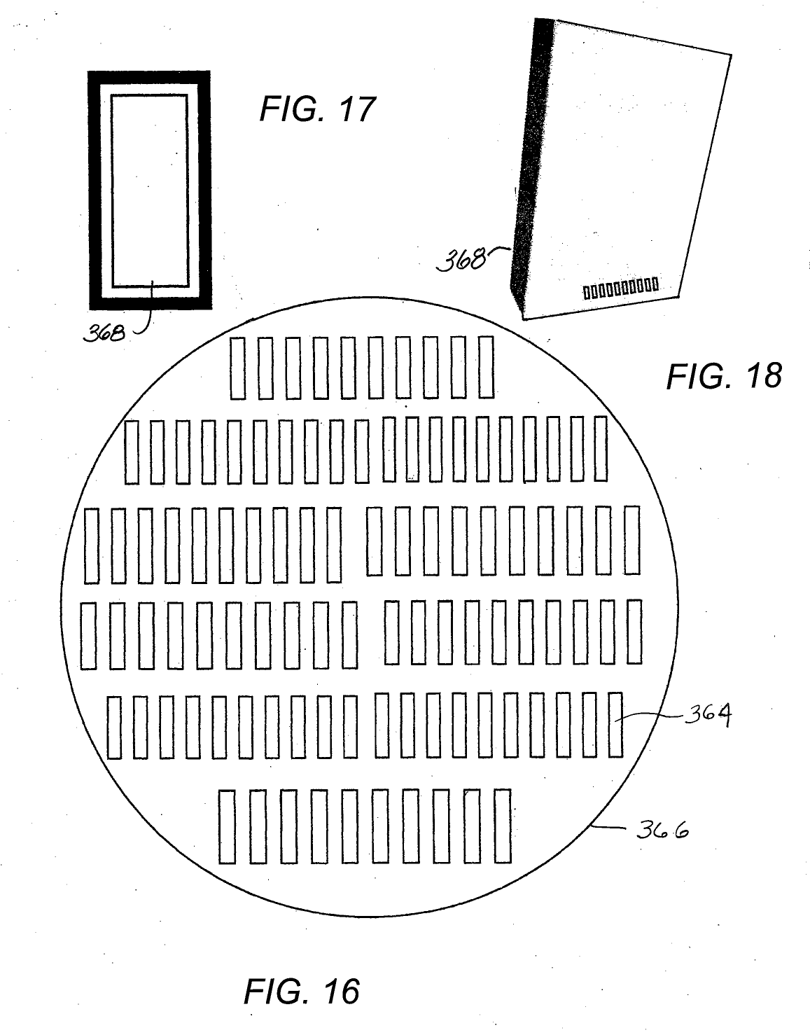

FIG. 16 illustrates micro-machined cavities 364 on a second silicon wafer 366. A single cavity 368 is shown in FIG. 17. When the second wafer 366 is bonded to the one 360 shown in FIG. 15, the entire device 368 is encapsulated in silicon as shown in FIG. 18, thereby eliminating the need for a separate plastic or metal product housing. The finished product is released by dicing the bonded silicon wafers into hundreds of individual finished products. This process enables miniaturization, weather and water proofing, low power consumption, and cost-effective mass production.

To achieve optimum miniaturization, lightness in weight, water and weather proofing, low energy consumption, mass batch manufacture capability, the device is fabricated monolithically in silicon with circuitry integrated with silicon micro-machined motion sensor, as well as power generators, and packaged through silicon wafer bonding.

Through the use of the IC approach described immediately above, the portable tracking unit may be reduced in size and weight to a dog tag size, as shown in FIG. 3. A flat disk-type battery may be used with the size decreasing even more, as shown in FIG. 14. With appropriate miniaturization, the entire tracking unit with battery may become an implantable device.

In brief summary, what has been disclosed and shown is a tracking system that is small in size and weight, is water proof, has low power consumption, can be tracked via the Internet and smart phone services, and is low in cost. Further enhancements include the creation of a central service facility that, through subscription arrangements, can control and organize all tracking services, alerts, and geographic presentations to smart phones or dedicated personal digital assistants (PDA). A hand held, battery-powered programming module may be used for setting service registration, the identification of the portable tracking unit, programming functions, the initial charge of the battery, and for unit maintenance.

The remote computing device is preferably a laptop computer or a smart phone. In accordance with the invention, the remote computing device may periodically notify a pet owner or animal tracker of a subject animal's location by, for example, transmitting a notification signal or e-mail message directly to the remote receiver or by posting information about the subject animal on a web server. In addition, a live operator may provide assistance over the telephone or via a computer or other communication device to help the pet owner/animal tracker in tracking the animal. The remote receiver may be located in the pet owner's or animal tracker's home or it may be a hand-held device carried by the pet owner or animal tracker that allows the pet owner to perform tracking and view the animal's habitat without intervention from a third party.

Although not mentioned in detail, a Subscriber Identity Module (“SIM”) card may be used with the device shown in FIG. 14. The SIM card may be programmed with various information concerning the tracking unit, the animal, the owner, and other information. In another embodiment, a SIM card may not be used and instead, programmable integrated circuit firmware is used.

Another feature not mentioned in detail is the use of burst transmission by interrogation or when beyond the programmed perimeter. Burst transmission should conserve battery power. In a further refinement, the portable tracking unit's operation may be configured to automatically go to a sleep mode under the condition of a low battery charge.

Available batteries and battery packs suffer from the replacement cost and inconvenience. They are heavy, can be unreliable, and in many cases, due to a ruggedization requirement, can be difficult to access. Traditional renewable energy devices do not fully address the need for a reliable and long life electrical energy source due to their poor performance in hostile environments. For example, solar cells are substantially non-operational at night or on severely overcast days. Wind converters are impractical for movable objects. However, the embodiments of the invention use a “movement-based” electrical generator that will function at night, during the day, rain or shine.

The pivoting power generator will produce electrical current at night and with or without wind. Linear power generators may also be usable through micro-fabrication techniques. In their simplest form a sliding magnet moves back and forth through a solenoid that may take the form of a spool of copper wire. An alternating current is induced in the loops of wire by Faraday's law of induction each time the magnet slides through. More particularly, a linear motion electric power generator typically comprises a moving magnet that is confined so that it can move with bi-directional linear, or approximately linear, motion through each of at least two coils. The coils are spaced apart from each other and connected electrically so that current produced in a first coil as a result of movement of the moving magnet is substantially in phase with current produced in said second coil. Power can be provided from extremely low-power mechanical forces.

Linear electric generators are available, can be fully encapsulated for ruggedization, and can be scaled depending on the power requirements. Surface finishes, high quality components, and correct energy processing yield a high efficiency at relatively low cost and weight. Friction between the sliding magnetic stacks and the inner wall of the generator can be made negligibly low. This not only reduces the frictional loss but also increases the system sensitivity to capture energy from the slightest movement. As magnets slide across induction coils in a tube, random AC outputs are produced. They are then rectified and regulated into a stable DC output to charge a battery with an overall net efficiency of over fifty percent over a wide temperature range. Energy production of one watt can be produced with only mild mechanical motion. The completely sealed structure makes the system corrosion resistant. The ultra low friction surfaces and simple design make the linear electric generator mechanically robust without any sign of mechanical degradation after months of continuous operation.

As used herein, the Global System for Mobile Communications (“GSM”), which was originally from Groupe Special Mobile of France, is presently the most widespread standard for mobile telephony systems in the world. With GSM, both signaling and speech channels are digital. The GSM standard has been an advantage to both consumers, who may benefit from the ability to roam and switch carriers without replacing phones, and also to network operators, who can choose equipment from many GSM equipment vendors. GSM also provides a low-cost implementation of the short message service (SMS), also called “text messaging,” which has since been supported on other mobile phone standards as well. However, this is just an embodiment of a mobile wireless communication system. Others may also be used and in general, a mobile wireless communication system may be referred to as a cell phone or cell phone system including a cell phone, cell phone tower, etc. The invention is not intended to be limited to any particular standard for wireless telephony system or any particular system unless so specified in the claims.

In a more advanced modification, the tracking unit may also be sensitive to receiving commands through a GSM receiver. Even though placed in a sleep state, commands from a remote site may be received through a GSM receiver in the tracking unit at which time, the processor will “wake up” the tracking unit, determine its position, and use the GSM transmitter to respond to the location request. Such modifications will require adding a GSM receiver or transceiver and further programming.

In still another embodiment of the invention, the tracking unit may also be used in aquatic environments where the object to be tracked is reachable by the GPS system. However the tracking unit must surface before it can communicate.

In accordance with another aspect, the tracking unit may include an increased memory size and programming of the processor to log object locations and movements in the memory for later access and downloading to determine the object's movements.

The term “collar,” as used herein, is not intended to be limited to the structures depicted in the figures but, rather, is intended to encompass a wide variety of devices including collars, harnesses, muzzles, saddles and the like. Animal collars contemplated here are formed of a durable, weather resistant material, e.g., leather, and a cover layer 512 comprising plastic or plastic-like material. The collar should be weather resistant and fire retardant. A reflective, or light-emitting, or phosphorescent substance that increases visibility of the animal collar in a dark environment may also be added.

The terms “mobile” and “portable” as used herein refer to a unit that may be hand held but also may be constructed to be self-contained so that they can be affixed to something else that is movable, such as a vehicle.

The terms “position information” or “location data” as used herein refer to information about the location of a tracked object. The term refers to the coordinates or geographic location of the object. The terms “position” and “location” are used interchangeably herein.

Accelerometers, or motion detectors are well known and their composition and detailed operation are not provided here. These devices can be made very small. For instance, micromechanical systems (“MEMS”) technology is used to construct accelerometers used in automotive airbag deployment systems; and their widespread use in these systems has driven down the cost of such accelerometers dramatically. Recent developments also include the use of accelerometers in digital interface control. Since 2005, Apple's laptop computers have featured an accelerometer known as Sudden Motion Sensor to protect against hard disk crashes in the event of a shock. Smart phones and personal digital assistants (such as Apple's iPhone and iPod Touch and the Nokia N95) contain accelerometers for user interface control, e.g., switching between portrait and landscape modes, and for recognizing other tilting of the device.

As used in the specification, the wireless communication link refers to any device that enables direct wireless communication with the components on the tracking unit. For example, the wireless communication link may be a Code-Division Multiple Access (CDMA) device that provides broadband access to the Internet. Alternatively, the wireless communication link could be a device that facilitates direct satellite communication from the animal collar to the remote receiver.

As used herein, the term “remote receiver” refers to a device capable of receiving and displaying video and text data. Exemplary suitable remote receivers include PCs, hand-held consumer electronic devices such as PDAs, PALs, iPads, standard consumer electronic devices such as smart watches and cell phones. The remote receiver may be resident at the pet owner's home or office. Alternatively, the remote receiver may be a hand-held device that the pet owner can carry as he or she searches for the pet.

Oceanographers may also study the behavior and habitat of sea creatures using the present invention. For example, an oceanographer may attach a collar in accordance with the invention to a sea creature and view and/or broadcast the images transmitted from the collar, preferably in real time.

This invention is also particularly useful for security personnel who employ guard dogs, for example. The animal collar of this invention may be worn by a guard dog that can patrol a building or area. The collar transmits location signals to the security personnel wherever they may be located which substantially increases the effective area that may be patrolled.

This invention is also useful for law enforcement personnel and rescue personnel. The collar according to the invention may be worn by, for example, narcotic sniffing canines or rescue animals who may be sent into areas that are either physically inaccessible or pose a significant threat to humans. Accordingly, the collar allows law enforcement personnel and rescue personnel to search areas that they otherwise would not search.

In addition, the invention may be employed with hunting dogs assist the hunter in locating his prey. In addition, the invention may be used by space exploration personnel to transmit images from outer space to earth. Numerous other uses will be apparent to the skilled artisan in view of the foregoing disclosure.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims.

What is claimed is:

1. A system for tracking the location of a movable object, the system comprising:
a portable tracking unit attached to the movable object, the tracking unit comprising:
an overhead position locater receiver configured to receive position signals from a plurality of overhead position location devices and provide overhead position location data from the received position signals;
a wireless communications transmitter configured to wirelessly transmit a tracking unit location signal representative of the geographic location of the tracking unit;
a motion detector configured to detect when the portable tracking unit is moving and to provide a motion signal;
a tracking unit processor programmed to receive the motion signal and control the receiver and transmitter to operate in a normal operation mode, to receive overhead position location data from the receiver, to process the overhead position location data to calculate the present geographic location of the tracking unit and provide a tracking unit location signal; to control the transmitter to wirelessly transmit the tracking unit location signal, and to control the transmitter and receiver to operate in a low-power consumption sleep mode;
a battery configured to provide electrical power to the receiver, transmitter, and processor; and
an electrical energy generator configured to transduce mechanical motion of the portable tracking unit into electrical energy, the electrical energy generator connected to the battery to automatically recharge the battery.

2. The tracking system of claim 1 wherein the motion detector comprises a multiple-axis motion detector.

3. The tracking system of claim 1 wherein the wireless communications transmitter is configured to transmit the tracking unit location signal in at least one of real time transmission, periodic transmission, and burst transmission.

4. The tracking system of claim 1 wherein the portable tracking unit further comprises a memory in which is stored an identification of the tracking unit;
wherein the tracking unit processor is further programmed to access the memory to retrieve the identification and to control the transmitter to transmit the identification with the calculated tracking unit location signal.

5. The tracking system of claim 1 further comprising a plurality of power generators, each of which is configured to transduce mechanical motion of the tracking unit to electrical energy, one of which is connected to recharge the battery, and another is connected directly to the transmitter to provide electrical power for operation thereof.

6. The tracking system of claim 1 wherein the portable tracking unit excepting the battery is fabricated monolithically in silicon with circuitry integrated with silicon micro-machined motion sensor, as well as power generators, and packaged through silicon wafer bonding whereby optimum miniaturization, lightness in weight, water and weather proofing, low energy consumption, mass batch manufacture capability are achieved.

7. The tracking system of claim 1 wherein the overhead position locator receiver is configured to receive position signals from a plurality of GPS satellites and provide GPS position location data from the received GPS position signals.

8. The tracking system of claim 1 further comprising a monitoring unit located remotely from the tracking unit, the monitoring unit comprising:
a monitoring unit memory in which is stored geographical data representing a safe geographic area in which the tracking unit is expected to remain;
a monitoring unit processor programmed to receive the tracking unit location signal, retrieve from the memory the data representing a safe geographic area, compare the tracking unit location to the safe geographic area data, and provide an alert signal if the location of the tracking unit is outside the safe geographic area.

9. The tracking system of claim 8 wherein the remote monitoring unit comprises a personal computer having the monitoring unit processor, the monitoring unit processor being further programmed to provide the alert in auditory form and in visual form.

10. The tracking system of claim 8 wherein the monitoring unit processor is further programmed to display the tracking unit's position in relation a geographical map.

11. The tracking system of claim 8 wherein the remote monitoring unit comprises a smart phone having the monitoring unit processor, the monitoring unit processor being further programmed to provide the alert in auditory form and in visual form.

12. The tracking system of claim 1 wherein the tracking unit processor is further programmed to periodically monitor the motion detector to determine if motion is detected, upon no more motion detected, to start a timer of predetermined time period, and having not received a motion signal within the time period, control the transmitter to go to a low power consumption sleep mode.

13. The tracking system of claim 12 wherein the battery power is always provided to the motion detector even when other devices are in sleep mode, with the tracking unit processor also having a low power consumption mode, but further programmed to continually monitor the motion detector for a motion signal, and upon receiving one, the tracking unit processor goes to a higher power consumption mode and also controls the transmitter to a higher power consumption mode.

14. The tracking system of claim 1 wherein the tracking unit further comprises a radio frequency signal device programmed to transmit an RF location signal in response to receiving a predefined query signal.

15. The tracking system of claim 14 wherein the tracking unit processor is further programmed to periodically transmit the RF location signal when reception of GPS signals cease for a predetermined period of time.

16. A system for tracking the location of a movable object, the system comprising:
a portable tracking unit attached to the movable object, the tracking unit comprising:
a GPS locator receiver configured to receive position signals from a plurality of GPS satellites and provide GPS position location data from the received position signals;
a GSM wireless communications transmitter configured to wirelessly transmit a tracking unit location signal representative of the geographic location of the tracking unit;
a multiple-axis motion detector configured to detect when the portable tracking unit is moving and to provide a motion signal;
a tracking unit processor programmed to receive the motion signal and control the receiver and transmitter to operate in a normal operation mode, to receive GPS location data from the receiver, to process the GPS position location data to calculate the present geographic location of the tracking unit and provide a tracking unit location signal; to control the GSM transmitter to wirelessly transmit the tracking unit location signal, and to control the GSM transmitter and GPS receiver to operate in a low-power consumption sleep mode;
a battery configured to provide electrical power to the receiver, transmitter, and tracking unit processor; and
a plurality of electrical energy generators configured to transduce mechanical motion of the portable tracking unit into electrical energy, the electrical energy generators connected to the battery to automatically recharge the battery, to the GPS receiver to power its operation, and to the GSM transmitter to power its operation;
a monitoring unit located remotely from the tracking unit, the monitoring unit comprising:
a monitoring unit memory in which is stored a series of geographical data representing a safe geographic area in which the tracking unit is expected to remain;
a monitoring unit processor programmed to receive the tracking unit location signal, retrieve from the memory the data representing a safe geographic area, compare the tracking unit location to the safe geographic area data, and provide an alert signal if the location of the tracking unit is outside the safe geographic area.

17. The tracking system of claim 16 wherein the wireless communications transmitter is configured to transmit the tracking unit location signal in at least one of real time transmission, periodic transmission, and burst transmission.

18. The tracking system of claim 16 wherein the tracking unit further comprises a radio frequency signal device programmed to transmit a location signal in response to receiving a predefined query signal.

19. The tracking system of claim 18 wherein the tracking unit processor is further programmed to periodically transmit the location signal when reception of GPS signals cease for a predetermined period of time.

20. The tracking system of claim 16 wherein the portable tracking unit excepting the battery is fabricated monolithically in silicon with circuitry integrated with silicon micro-machined motion sensor, as well as power generators, and packaged through silicon wafer bonding whereby optimum miniaturization, lightness in weight, water and weather proofing, low energy consumption, mass batch manufacture capability are achieved.

21. A method for tracking the location of a movable object, the system comprising:
receiving position signals from a plurality of overhead position location devices;
processing the received signals to extract location assist data and providing overhead position location data from the received position signals;
detecting motion of the movable object and providing a motion signal;
upon receiving the motion signal, processing the overhead position location data to calculate the present geographic location of the movable object and generate a movable object location signal;
wirelessly transmitting movable object location signal representative of the geographic location of the movable object;
providing operational power from a battery source located with the movable object;
transducing mechanical movement of the movable object into electrical energy and recharging the battery source with the transduced electrical energy;
operating in a low power consumption move when the movable object is stationary;
receiving the geographic location signal representative of the movable object at a location remote from the movable object; and
processing the received geographic location signal of the movable object and displaying the geographic location of the movable object in relation to a geographic coordinate map.

22. The method of claim 21 further comprising powering each of the receiving and transmitting steps by separately transducing mechanical motion of the movable object and separately providing electrical energy with which to perform the receiving and transmitting steps.

23. The method of claim 21 further comprising transmitting a location signal in response to receiving a predefined query signal; and
periodically transmitting the location signal when reception of GPS signals cease for a predetermined period of time.

24. The method of claim 21 further comprising fabricating devices, excepting a battery, monolithically in silicon with circuitry integrated with silicon micro-machined motion sensor, as well as power generators, and packaged through silicon wafer bonding whereby optimum miniaturization, lightness in weight, water and weather proofing, low energy consumption, mass batch manufacture capability are achieved.
